(19) United States
(12) Patent Application Publication
(10) Pub. No.: US 2024/0181441 A1
(43) Pub. Date: Jun. 6, 2024

(54) A DROPLET STEERING APPARATUS

(71) Applicant: POLY PICO TECHNOLOGIES LIMITED, Cork (IE)

(72) Inventors: Gabriel LEEN, Cork (IE); Nikolay PAVLOV, Cork (IE)

(73) Assignee: POLY PICO TECHNOLOGIES LIMITED, Cork (IE)

(21) Appl. No.: 18/546,575

(22) PCT Filed: Feb. 17, 2022
(86) PCT No.: PCT/EP2022/054019

§ 371 Date: Aug. 15, 2023

(30) Foreign Application Priority Data
Feb. 19, 2021 (EP) 21158295.2

(51) Int. Cl. B01L 3/02

(52) U.S. Cl. CPC B01L 3/0268; B01L 2200/0626; B01L 2400/0415

(57) ABSTRACT

An apparatus provides precise steering of inkjet droplets to a substrate by use of multipole arrangement with electrodes on a resistive plate. There may be droplet detection based on charge sensing. A hexagonal spiral deposition pattern on a target substrate allows fast uniform printing covering a nearly circular hexagonal area. There may be six electrodes arranged to form a cubic enclosure, and injected droplets may be merged within the enclosure, and their charge controlled by merging of source droplets of differing charges to provide a net charge for biasing onward steering.

### INTRODUCTION

The present invention relates to dispensing of droplets such as inkjet droplets for manufacturing. The invention relates particularly to working with droplets in the range of diameters from lum to 1000 μm.

There exists a need for a micro/nano manufacturing process which allows precise patterning of a substrate with ejected droplets in the above range. In particular, there is a strong requirement to precisely place droplets at high speed without moving mechanical parts, to achieve highly reproducible positioning of the droplets.

The list of references below set out information in the public domain of background interest in this field.

The invention is directed towards providing improved steering of droplets in a path from a dispenser to target substrate.

### REFERENCES

[1] LINEAR QUADRUPOLE FOCUSING FOR HIGH RESOLUTION MICRODROPLET-BASED FABRICATION. Stephen F Heston, MST thesis, University of Pittsburgh, 2002 http://d-scholarship.pitt.edu/9947/
[2] US2013/0314472A1,
[3] Drop Charging and Deflection in an Electrostatic Ink Jet Printer. G. L. Fillmore at al. IBM Journal of Research and Development, Volume: 21, Issue: 1, January 1977.
[4] High Frequency Recording with Electrostatically Deflected Ink Jets. Richard G. Sweet. Citation: Rev. Sci. Instrum. 36, 131 (1965)
[5] U.S. Pat. No. 4,167,741
[6] U.S. Pat. No. 4,314,258
[7] A TWISTED ELECTROSTATIC QUADRUPOLE FOR GUIDING HEAVY CHARGED PARTICLES. By F. S. CHUTE, F. E. VERMEULEN and E. A. YOUSSEF. NUCLEAR INSTRUMENTS AND METHODS 82 (1970) https://doi.org/10.1016/0029-554X(70)90330-7
[8] Positioning of the rf potential minimum line of a linear Paul trap with micro-meter precision, P. F. Herskind at al. Journal of Physics B Atomic Molecular and Optical Physics 42(15) doi.org/10.1088/0953-4075/42/15/154008
[9] C. Ng, K & V. Ford, J & C. Jacobson, S & M. Ramsey, J & Barnes, Michael. (2000). Polymer microparticle arrays from electrodynamically focused microdroplet streams. Review of Scientific Instruments. 71. 2497-2499. https://doi.org/10.1063/1.1150642
[10] A Coriolis force in an inertial frame. Kirillov, Oleg and Levi, Mark (2017) Nonlinearity, 30(3). pp. 1109-1119. ISSN 0951-7715 DOI:10.1063/1.115064
[11] Drop Charging and Deflection in an Electrostatic Ink Jet Printer. G. L. Fillmore at al. IBM Journal of Research and Development, Volume: 21, Issue: 1, January 1977. DOI: 10.1147/rd.211.0037
[12] High Frequency Recording with Electrostatically Deflected Ink Jets. Richard G. Sweet. Citation: Rev. Sci. Instrum. 36, 131 (1965). https://doi.org/10.1063/1.1719502
[13] 142A, B, and C Preamplifiers. Ortec Inc. brochure. www.ortec-online.com
[14] U.S. Pat. No. 4,550,321.
[15] U.S. Pat. No. 6,764,168 B1
[16] US 2018/0111312 A1
[17] Accelerated Reaction Kinetics in Microdroplets: Overview and Recent Developments. Zhenwei Wei at al. Annu. Rev. Phys. Chem. 2020. 71:31-51
[18] Droplet microfluidics: a tool for biology, chemistry and nanotechnology. Mashaghi, S., Abbaspourrad, A., Weitz, D. A. & van Oijen, A. M. (2016). Trends in Analytical Chemistry, 82 118-125.
[19] Acceleration of reaction in charged microdroplets. Jae Kyoo Lee at al. Republic of Korea Quarterly Reviews of Biophysics (2015), 48(4), pages 437-444
[20] Droplet digital PCR of viral DNA/RNA, current progress, challenges, and future perspectives. Amir Asri Kojabad at al. J Med Virol. 2021 July; 93(7):4182-4197
[21] Stephen J. Brotton, Ralf I. Kaiser. Controlled Chemistry via Contactless Manipulation and Merging of Droplets in an Acoustic Levitator. Analytical Chemistry, 2020; 92 (12): 8371
[22] A Comprehensive Review of Detection Methods for SARS-CoV-2. Aziz Eftekhari. Special Issue COVID-19: Focusing on Epidemiologic, Virologic, and Clinical Studies)
[22] Microdroplet Chemistry: Difference of Organic Reactions between Bulk Solution and Aqueous Microdroplets. Soyul Kwak at al. Academ J Polym Sci 1(1): AJOP.MS.ID.555551 (2018)

### SUMMARY

According to the invention there is provided a droplet or particle steering apparatus comprising a liquid reservoir a steering guide comprising a plurality of electrodes which create an electric field through which a droplet travels while being controlled in two or three spatial dimensions, and a voltage driver for applying potentials to the electrodes according to control signals from a controller to steer the path of the droplets. Various optional features of the invention are set out in the dependent claims 2 to 57.

We describe an apparatus comprising a liquid reservoir, a steering guide comprising a plurality of electrodes which create an electric field through which a droplet travels towards a target substrate while being controlled in two or three spatial dimensions, and a voltage driver for applying potentials to the electrodes according to control signals from a controller to steer the path of the droplets.

In some examples, the electrodes are part of a resistive plate which extends around the path. In some examples, there are at least three electrodes on the plate. In some examples, the resistive plate has a hole through which the droplet path extends substantially perpendicularly to the plate.

In some examples, there are between 3 and 1024 electrodes. In some examples, the controller is adapted to alter the charge of droplets between positively charged and negatively charged. In some examples, the apparatus comprises an electrode in the reservoir, and potential applied to said electrode and other electrodes is controlled.

In some examples, the apparatus comprises an electrode in the reservoir, in contact with liquid in the reservoir, and potential across said electrode and other electrodes is controlled.

In some examples, the apparatus comprises an electrode through which the drops travel, in order to charge the droplets and potential across said electrode and other electrodes is controlled.

In some examples, the electrodes are arranged as three-dimensional shapes having a dimension substantially parallel to the droplet path. In some examples, at least some of the electrodes are elongate, in the form of pillars or are helical in shape for example. In some examples, there are four or eight electrodes. In some examples, the electrodes are mounted to a tubular support which defines a cylindrical droplet path surrounded by the electrodes, and the tubular support and/or the electrodes may be flexible. In some examples, the controller is configured to control dynamic electrical potential applied to the electrodes and due to the physical shape of the electrodes, a component of force axial to the conduit is applied to droplets in the conduit, which in turn causes them to accelerate along the central axis of the conduit.

In some examples, the controller is configured to perform droplet control without use of any electrode in the reservoir or on, or under, a target landing zone. In some examples, the controller is configured to drive the electrodes with application of a saddle-shaped field that defines a saddle point in space whereby droplets of different parameters such as charge or mass are focused toward the saddle point.

In some examples, the controller is configured to drive the electrodes such that the location of the saddle point within the space bounded by the electrodes is controlled.

In some examples, the controller is configured to drive the electrodes for deposition of droplets onto a defined location, and/or for free air levitated transport of droplets, and/or for selective merging of droplets in free air or other gas.

In some examples, the potential difference across at least two electrodes in in the range of 100 V to 300 kV. In some examples, the potential difference between electrodes in the plane of the resistive plate is different from that between the reservoir liquid and the resistive plate to an extent of 100V to 300 kV.

In some examples, there is an electrode on the target substrate, and potential applied to said electrode and other electrodes is changed for droplet steering.

In some examples, the target substrate comprises wells, and electrodes are mounted adjacent said wells and are electrically biased to attract the droplets to particular wells.

In some examples, the target substrate comprises patterned electrodes. In some examples, the patterned electrodes are in a plate underneath the target substrate. In some examples, the plate is patterned such that the electrical potential is concentrated at certain locations which may attract or repel droplets.

In some examples, the apparatus comprises a feedback mechanism to detect the arrival of a droplet on or above the target substrate. In some examples, the controller and the driver are configured to accelerate droplets by superimposed constant electric field.

In some examples, the apparatus comprises a droplet sensor, and the controller is configured to use sensor signals for estimation of the volume dispensed.

In some examples, the controller is configured to dynamically deposit droplets to different locations based on their estimated properties. In some examples, the controller is configured to apply drive signals so that the droplets are deposited in a spiral pattern.

In some examples, the controller is configured to apply drive signals so that droplets are merged in free space by being focused to the same location.

In some examples, the controller is configured to apply an alternating quadrupole electric field with use of variable focus position which is achieved by adjustment of both amplitudes and phases of the voltages applied to the electrodes.

In some examples, the controller is configured to drive the electrodes with an alternating quadrupole electric field if the electrodes are mounted to a resistive plate or the electrodes (61-64) are arranged as three-dimensional shapes having a dimension substantially parallel to the droplet path.

### DETAILED DESCRIPTION OF THE INVENTION

The invention will be more clearly understood from the following description of some embodiments thereof, given by way of example only with reference to the accompanying drawings in which:

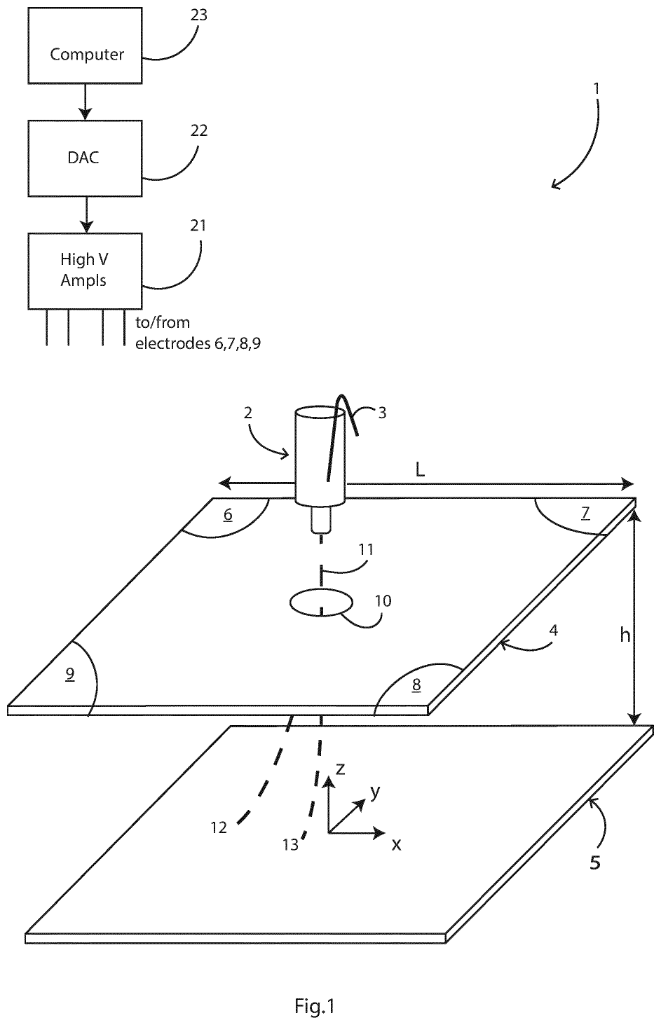

FIG. 1 is a perspective view of a droplet steering apparatus of the invention, with four-channel based X-Y guiding, in which a liquid-contacting electrode is grounded, and the droplets are guided to various targeted locations and a target plate is under high potential;

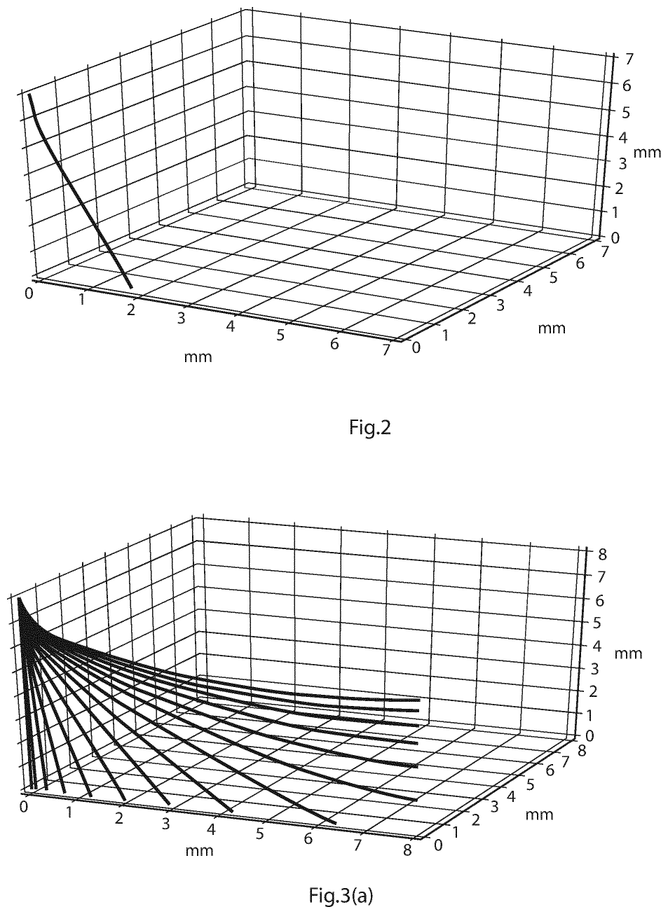

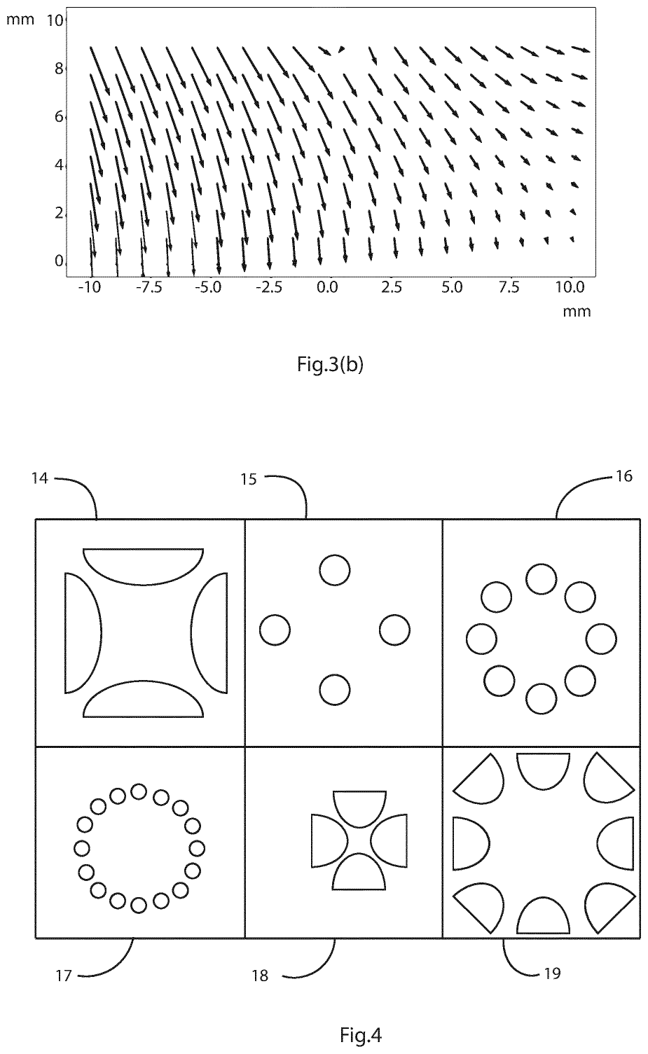

FIG. 2 shows numerical simulation of a water droplet path in the apparatus of FIG. 1, with +/−10% variations in the droplet charge, droplet diameter 50 μm, and droplet charging potential of 400V, FIG. 3(a) shows simulation of electrical guiding of such droplets at different deflection voltages, and FIG. 3(b) shows simulation of an electric filed in a Faraday Line Steering (FLS) electrode-based driving approach,

FIG. 4 shows example electrode configurations for a resistance plate or for a linear quadrupole electrostatic steering device other multipole electrostatic focusing device.

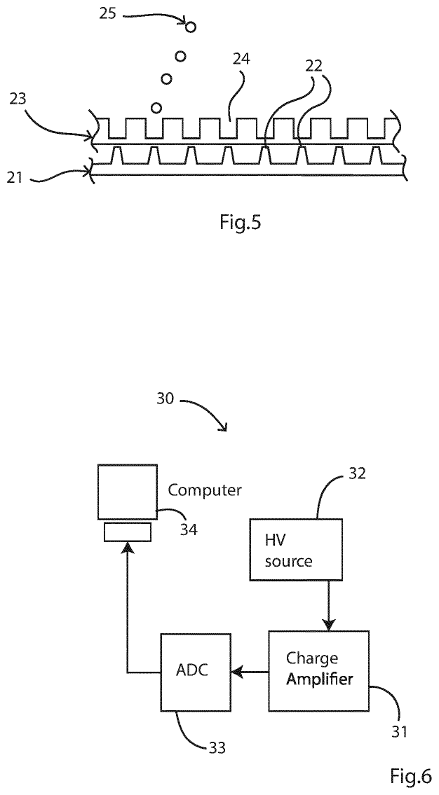

FIG. 5 shows a substrate holder for a substrate provided with wells, and in which electrodes of the holder are electrically biased to attract the droplets to the corresponding wells of the substrate.

FIG. 6 shows an apparatus controller in which a charge amplifier senses droplet deposition.

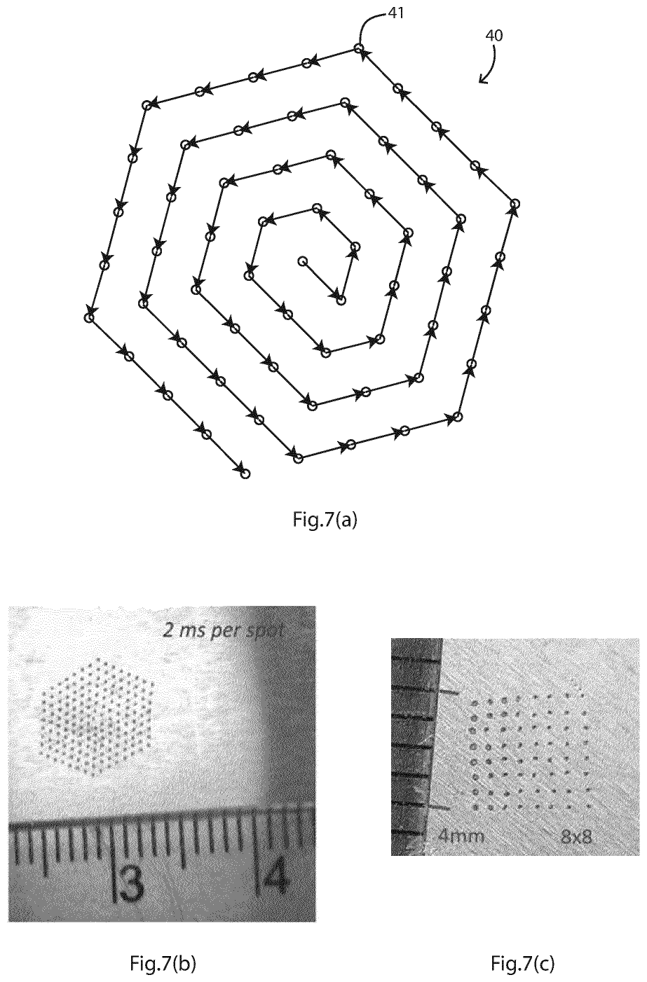

FIG. 7(a) shows a spiral dispense sequence pattern, to allow fast uniform covering of a nearly circular area because of minimizing steering steps and changes in their direction, and in which the dispensing starts in the centre, so minimizing placement deviation due to unsettled parameters of the first droplet packet, FIG. 7(b) is an image of such a pattern, and FIG. 7(c) is an image of an alternative deposit pattern,

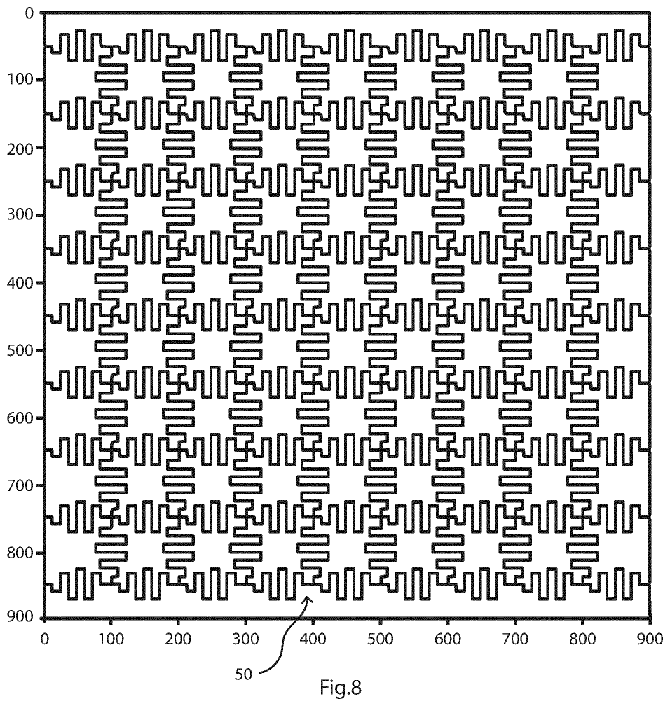

FIG. 8 shows meander patterning of a resistive plane, allowing use of films with lower film resistance (kOhm/square) which improve manufacturability,

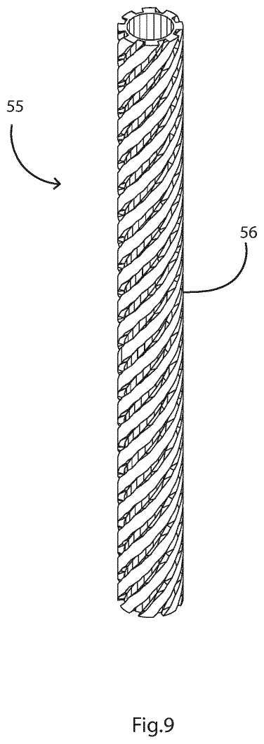

FIG. 9 shows a conduit with a circular internal cross-section and grooves on the external surface in a helical configuration which house 8 electrodes for droplet guiding, which is an embodiment of the linear quadrupole electrostatic focusing device type structure,

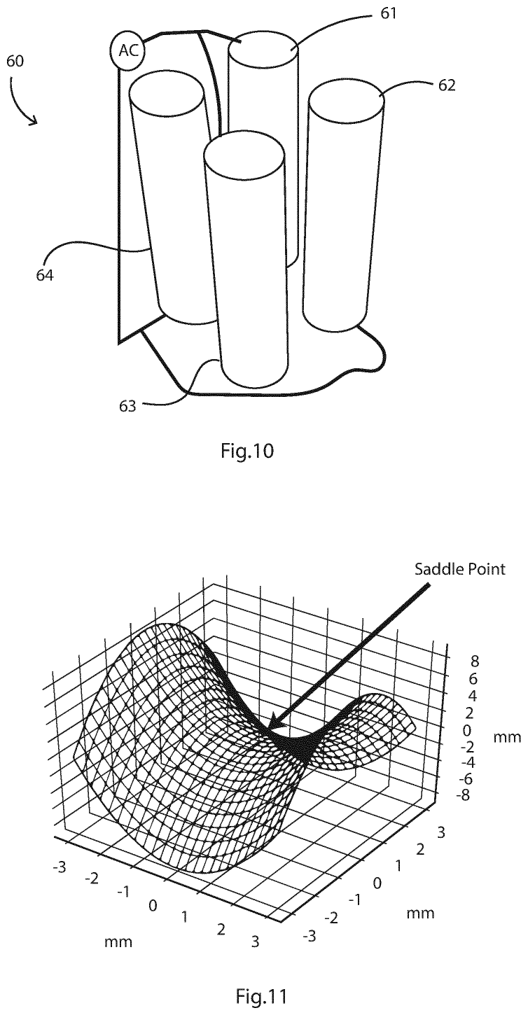

FIG. 10 shows a Linear Quadrupole Electrostatic Trap having four electrodes, showing connection to an AC (alternating current) voltage source, which is a simple electrode configuration, and in which various ratios of electrode diameter to electrode spacing can be used, and also patterns deviating from axial or other symmetry and with varying cross-section can also be implemented as embodiments,

FIG. 11 is a plot of electrical potential in a linear quadrupole electrostatic focusing device type structure having a ‘saddle point’ which acts as a focusing point for the droplets, depicting an ideal target configuration of electrical potential or approximation of real potential in the vicinity of the saddle point,

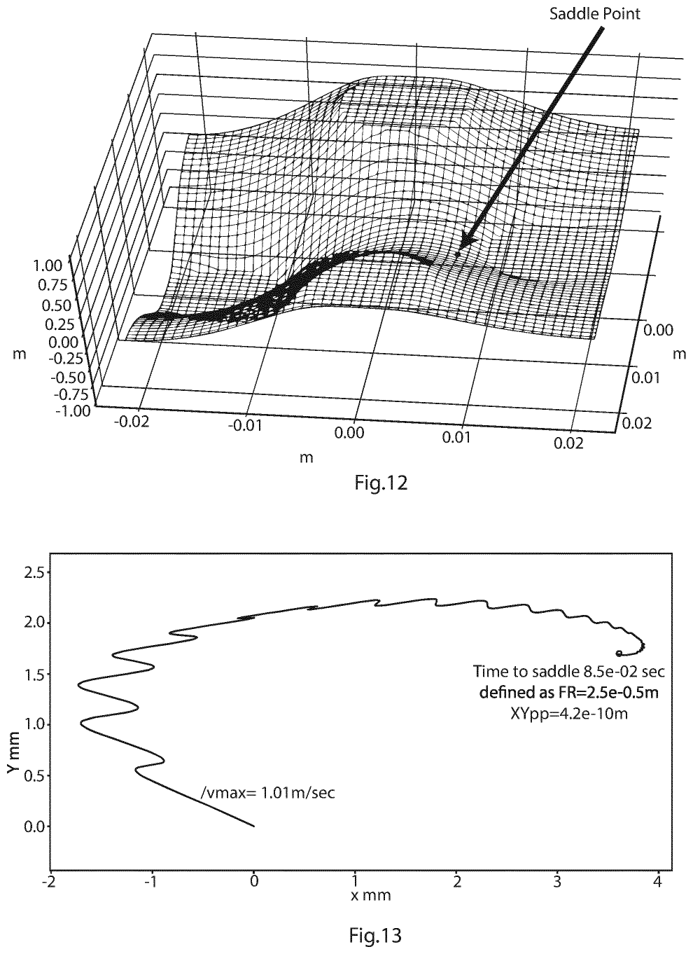

FIG. 12 is a plot of electrical potential in a linear quadrupole electrostatic focusing device type structure created by four cylindrical electrodes having a saddle point (marked) at X=7.0 mm, Y=3.7 mm, in which the amplitudes of the potential of the electrodes near the saddle point is the smallest,

FIG. 13 is a simulated example plot of XY plane droplet movement to a predefined target location, in a linear quadrupole electrostatic focusing device type structure, in which an excessive voltage amplitude causes overshoot of the motion toward the saddle point in which the droplet enters the trap at location (3.7, 1.6) and follows a path which brings it to a saddle point at location (0, 0), and the time taken for the droplet to reach the target location from the point of entry in this example is 85 ms;

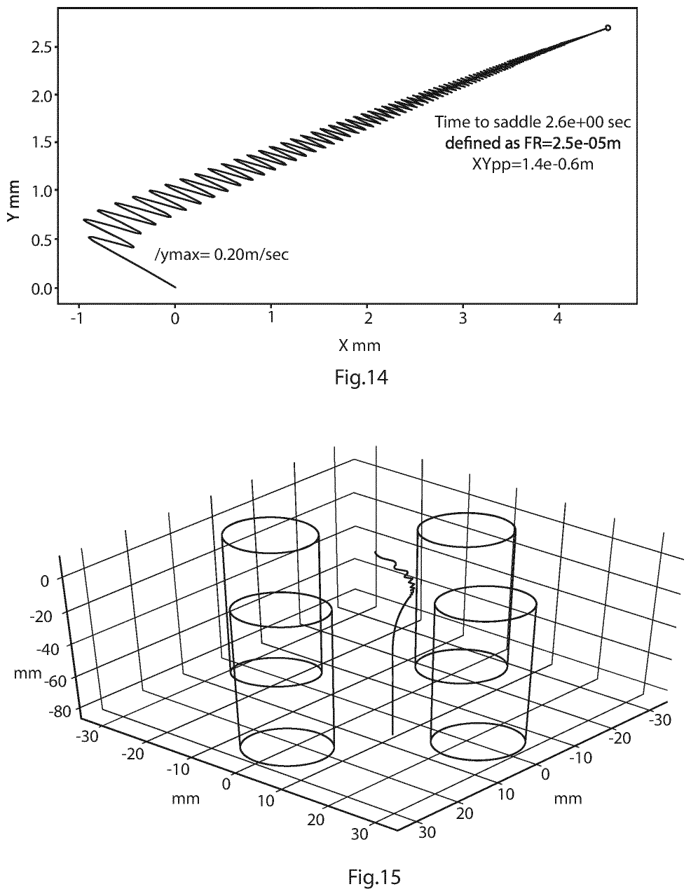

FIG. 14 is a simulated example plot of slower XY droplet movement, in a linear quadrupole electrostatic focusing device type structure, using a relatively low voltage, in which there is no overshoot of the movement, however the movement to the saddle point take a relatively long time: 2.6 seconds,

FIG. 15 shows simulation of steering a charged droplet using four electrodes, in a linear quadrupole electrostatic focusing device type structure, the plot showing droplet oscillatory micromotion, which decreases in amplitude as the saddle point is approached,

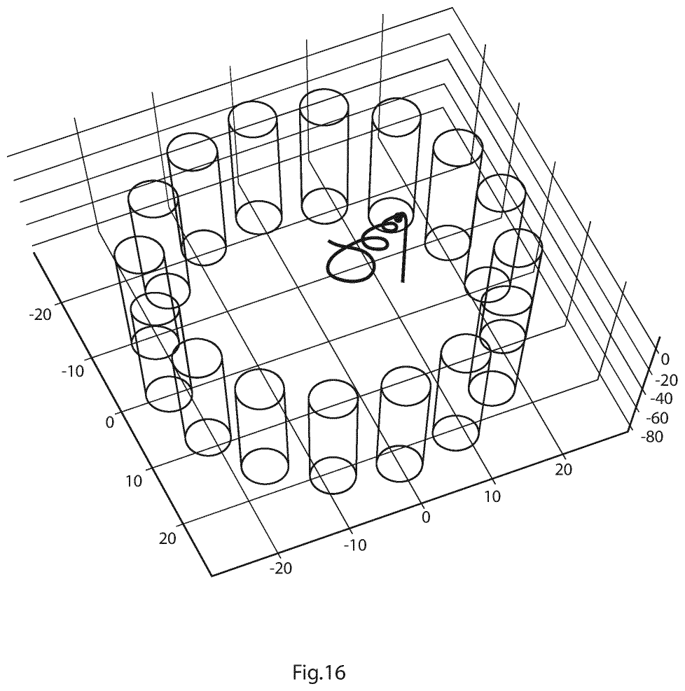

FIG. 16 shows simulation of a in a linear quadrupole electrostatic focusing device type system having 16 electrodes, showing a circular collapsing spiral type pattern of micromotion characteristic for the motion a droplet would exhibit in a rotating saddle potential,

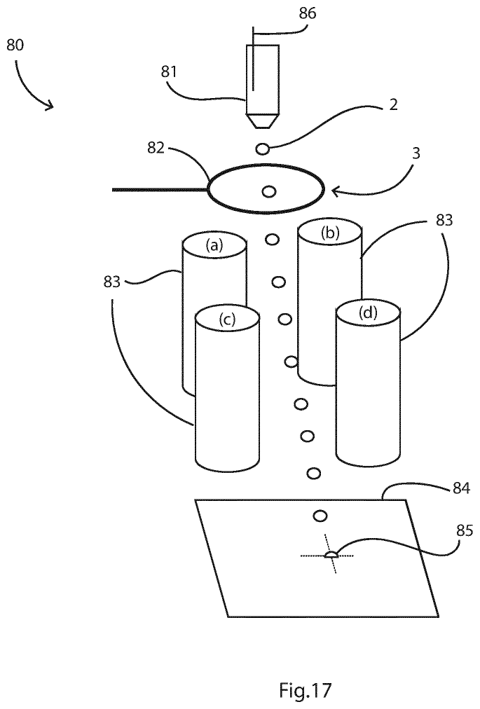

FIG. 17 shows an apparatus having a charging ring electrode above pillar electrodes of a linear quadrupole electrostatic focusing device,

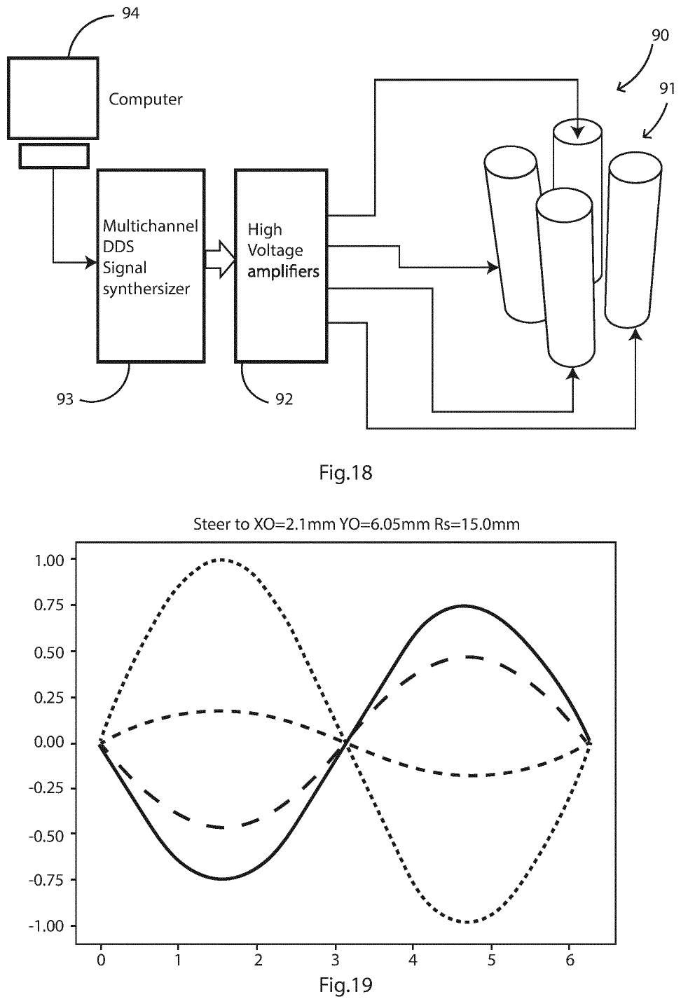

FIG. 18 shows an example of a linear quadrupole electrostatic focusing device type apparatus with a multichannel DDS (Direct Digital Synthesizer) as the signal source,

FIG. 19 illustrates one example of the voltages applied to four electrodes of either a FLS or a AQF structure;

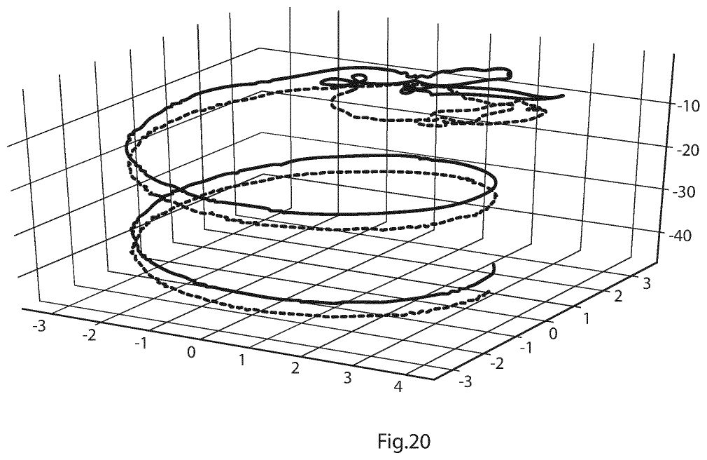

FIG. 20 illustrates one example of the path travelled by droplets in an AQF type transport structure which has helical electrodes (axis dimensions in mm); and

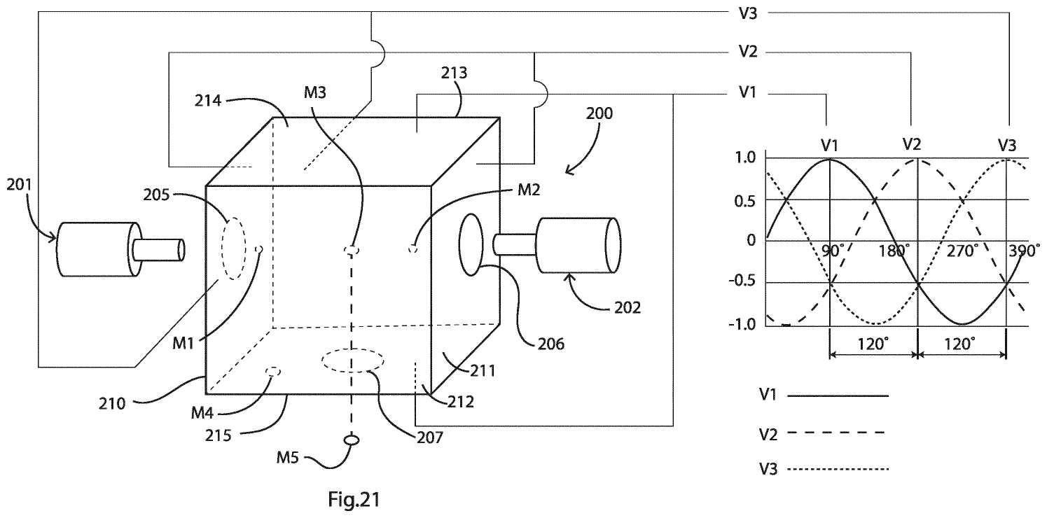

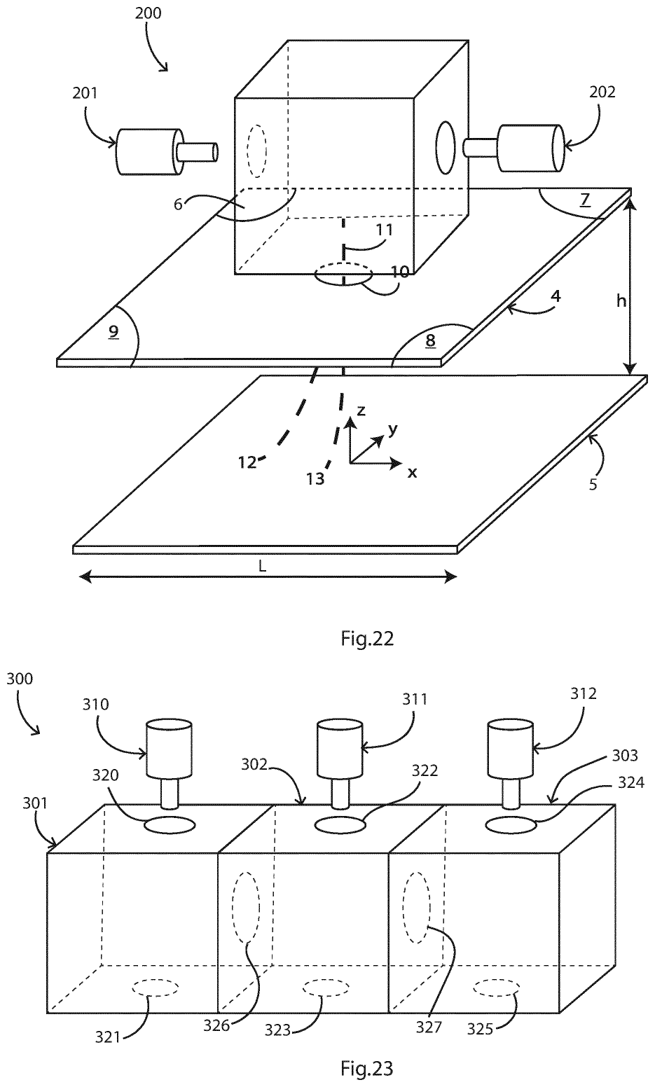

FIG. 21 is a diagram showing an apparatus with a chamber for droplet manipulation in three dimensions, FIG. 22 shows an apparatus with the arrangement of FIG. 21 appended to a droplet inlet end of an FLS apparatus of FIG. 1, and FIG. 23 shows an apparatus with multiple juxtaposed and inter-linked chambers.

### DETAILED DESCRIPTION OF THE INVENTION

We describe in various embodiments an apparatus for controlling the trajectory of a droplet in three dimensions for a desired two-dimensional pattern on a target substrate, and capable of guiding the trajectory of a droplet to a defined location. Major applications are for example printing microarrays, needleless injection through skin, or 3D printing. Other examples are filling TEM (Transmission Electron Microscopy) grids, filling cavities in microneedle moulds, and delivering pharmaceuticals to microneedle arrays.

The embodiments of the invention can be classified in two droplet steering approaches which can be abbreviated as AQF (Alternating Quadrupole Focusing), and FLS (Faraday Line Steering). FIGS. 1, 2, 3 and 8 correspond to the FLS approach, FIGS. 9 to 18 relate to the AQF approach, while FIGS. 1, 4, 5, 6, and 7, correspond to both approaches. The AQF approach can be based on either pillar electrodes or resistive plate steering. The invention relates particularly to working with droplets or particles in the range of diameters from 1 μm to 1000 μm, more preferably 5 μm to 300 μm. However the invention can also work below the lower end of this range to including aerosol droplets which are typically in the order of 5 μm but may have particles/droplets which are smaller than 1 μm.

FLS Approach

As shown in FIG. 1 a droplet steering apparatus 1 comprises a liquid reservoir 2 having a volume between 1 microliters (μL) to 200 millilitres (mL), in this example, however the volume of fluid and its delivery mechanism may vary in other embodiments. An electrode 3 is in contact with the liquid in the reservoir 2 and is used to control the electrical potential of the liquid being dispensed from a nozzle of the reservoir 2. There is a resistive plate 4 beneath the reservoir and beneath that, a target substrate plate 5. The resistive plate 4 has four electrodes 6, 7, 8, and 9 at its four corners, and it has a central aperture 10 directly beneath the nozzle of the reservoir 2. Droplets 11 which are dispensed from the reservoir nozzle are steered as they pass through the aperture 10, and for illustrative purposes two deposition locations 12 and 13 are shown on the target substrate plate 5. Steering control is provided by high voltage amplifiers 21 driving the electrodes 6-9 and receiving signals from a DAC 22 which is in turn controlled by a host computer 23.

The droplets are charged by potential difference between the reservoir 2 and the resistive plate 4.

The apparatus 1 can be used with either the FLS or the AQF control technique applied.

Ejected droplets 11 are charged by the relative potential difference of the resistive plate 4 and are hence guided through the aperture 10. The droplets are simultaneously deflected by an electric field defined by the four electrodes 6, 7, 8, and 9 towards specific locations, such as those indicated by locations 12 and 13 on the conductive target substrate plate 5. The electrode 3 in the reservoir provides control of the potential of the liquid in the reservoir, and the difference between potential of the electrode 3 and the target substrate plate 5 is controlled. The liquid electrode 3 can be either grounded or, in some implementations, supplied with a high potential and thus allowing the system to operate with a grounded target substrate plate 5.

The object onto which the droplets are to be deposited may be the target substrate itself or it may be an item placed on a target substrate plate.

The high-voltage amplifiers 21 are an electrical waveform generator which alter the potential of the resistive plate electrodes 6-9 relative to each other. The resistive plate 4 therefore generates an electrical field which alters the trajectory of a charged droplet, as shown in the examples of FIGS. 2 and 3(a).

In various examples there are between 3 and 1024 electrodes. The electrodes may have any of a number of physical patterns in two dimensions on the resistive plate, and some examples are shown in FIG. 4. Note that the aperture in the plate is not illustrated in FIG. 4. These examples include: four segment-shaped electrodes 14, four disc-shaped electrodes 15, eight disc-shaped electrodes 16, sixteen disc-shaped electrodes 17, four segment-shaped electrodes 18, and eight segment-shaped electrodes 19. Such example electrode configurations may also be implemented not only on a resistive plate as is the case for FLS, but also as a pattern of electrodes in AQF where the electrodes are 3-dimensional structures and the area surrounded by the electrodes is free space and generally corresponds to the location of the droplet path.

Some examples of potential on the electrodes 6-9, are −750V, −750V, 3250V, 3250V, respectively, with the target substrate plate 5 at 0V and the liquid electrode 3 at 4500V. Numerical simulation of the electric field for such an example is presented in FIG. 3(b). In general, preferably, the potential difference between the liquid electrode and the target substrate is in the range of 500V to 10000V, and more preferably greater than 4000V.

The FLS approach advantageously causes simultaneous electrostatic acceleration and two-dimensional electrostatic deflection due to potential gradient across the gap h between the resistive plate 4 and the target substrate plate 5 and across the resistive plate 4 itself.

Such an approach can be called Faraday Line Steering because the droplet generally follows the direction of electric field thus travelling along so-called electric lines of force.

A parameter which is controlled in some embodiments is the potential between the resistive plate and the target substrate, separated by a distance h, shown in FIG. 1. This parameter can alter the acceleration of the droplets, thereby providing another dimension to the control of the droplet's motion. Electrical deflection and acceleration of droplets may be performed simultaneously in order to increase the precision of the droplet positioning on the target object. The potential difference between the liquid reservoir and the centre of the resistive plate primarily determines the level of inductive charging of the droplet. The potential of the centre of the resistive plate is equal to the averaged potential of the plate electrodes. The difference between this potential and the potential of the target substrate plate primarily determines the acceleration of the droplet due to electrical forces and can be referred to as the acceleration voltage. The deflection of the droplet may be defined by the ratio of potential difference (voltage) across the resistive plate and the acceleration voltage.

FIG. 5 shows an electrode plate 21 with electrode ridges 22 under a target substrate 23 provided with wells 24. The electrodes 22 beneath the substrate 23 are electrically biased to attract the droplets 25 to the corresponding wells 24. This application is particularly advantageous for filling microneedle moulds. Such an approach combined with either FLS or AQF simplifies precise micropatterning or precise depositing of droplets at well-defined locations.

FIG. 6 shows an apparatus controller 30 for the detection and verification of successful droplet dispensing. The apparatus controller 30 includes a charge amplifier 31 linked with a high voltage source 32 and linked with an Analogue to Digital Converter (ADC) 33, in turn linked with a computer 34. The droplet detection approach can be used with or without droplet focusing/steering. The resistive plate and/or reservoir liquid electrodes are driven by High Voltage amplifiers, not shown in FIG. 6. The charge amplifier 31 senses the charge induced by arriving charged droplets on the conductive target substrate plate 5 (which might be placed under either conductive or non-conductive targets to be dispensed onto) and the computer 34 which processes the charge signals to determine when and where droplets have been deposited. There are preferably three or more charge amplifiers for positional accuracy. Alternatively or additionally, a charge amplifier may be connected to the reservoir electrode 3 which may be either grounded or under elevated potential. In one example embodiment, droplets of diameter 35 μm are charged to a potential of 400V carry charge of 780 fC (femtoCoulombs) or about 4.8 million elementary (electron) charges. Such amounts of charge are readily detected by industry-standard charge amplifiers such as the industry standard 142A/B/C Preamplifiers by Ortec Inc. [13]. This detection method differs from and where the droplet detection approach relies on charge induced by a droplet while it passes electrodes, whereas in this here disclosed method detection is achieved by sensing the charge removed or delivered by droplet leaving from the fluid reservoir or arriving at the target substrate.

FIG. 7(a) shows an example of a dispense pattern 40 of droplets, labelled 41 illustrating droplet locations on a target substrate based on a hexagonal spiral. The arrows in FIG. 7(a) indicate the temporal sequence in which droplets are dispensed. The pattern can be scaled for a different number of target locations. This arrangement allows for fast and uniform covering of a nearly circular area because the pattern of locations to be deposited onto minimises to a high degree the required angular deflection needed to change the focus between successive deposition locations. The dispensing starts in the centre location, so minimising placement deviation due to unsettled parameters of the first droplets dispensed. Such hexagonal grid pattern, where distance to all neighbour spots are equal, presents the most uniform way of discretely dispensing onto an area using either of the disclosed FLS or AQF methods.

In one specific example, the four resistive plate corner electrodes were driven by time varying voltages so as to direct a stream of droplets to 169 defined locations to provide 169 deposits as illustrated in Fig (b). The sequence in which the droplets were dispensed is similar to the sequence illustrated in FIG. 7(a). Each location has 45 droplets dispensed onto it to form the deposit; the time to dispense 45 droplets onto a given location was approximately 2 ms; the single droplet volume is approximately 50 pl; the total number of droplets dispensed was 7,605; the distance between the resistive plate 4 and the target was 18 mm and the total time to dispense the pattern was 3.1 sec. The target plate voltage in this example was 6 kV.

In another specific example, the four resistive plate corner electrodes 6-9 were driven by time varying voltages so as to direct a stream of droplets to 64 defined locations to provide an array of deposits as illustrated in FIG. 7(c). The sequence in which the deposits were dispensed was one column at a time, starting at the left most column. The number of droplets deposited in each column varies from 100 in the first row to 30 in the last column. The single droplets volume was approximately 50 pl; the distance between the resistive plate and the target was 18 mm; the total number of droplets dispensed was 5,560; the total time to dispense the deposit pattern was 2.6 sec. The target plate voltage in this example was 6 kV.

FIG. 8 shows a meander pattern 50 of resistive film on a resistive plate, allowing use of films with lower film resistance (kOhm/square), which improve manufacturability of a device. The through hole and electrode contacts are not shown in FIG. 8. Due to the various design parameters of resistive plates, a wide variety of resistive film patterns alternative to the pattern 50 may be preferred. High-resistivity films such as Ruthenium Oxide or Carbon can be manufactured using for example vacuum deposition or screen-printing techniques.

FIG. 9 shows an assembly 55 shows a conduit with a circular internal cross-section and grooves 56 on the external surface in a helical configuration, which house 8 electrodes, which are not shown. Electrical conductors are placed in the grooves such that the conductors form a helical pattern around the outside of the conduit. The helical conductors serve as quadrupole type focusing electrodes as described in the AQF embodiment. By controlling the dynamic electrical potential applied to the electrodes and due to the physical shape of the electrodes, a component of force axial to the conduit can be applied to droplets in the conduit, which in turn causes them to accelerate along the central axis of the conduit. The helical electrode embodiment allows for substantial deformation and therefore can be made flexible, for example it can be implemented as a hollow plastics tube with embedded conductors using well established cable technology. Such flexible hollow tube with helical electrodes can be used to transport charged droplets containing materials such as: nanoparticles; polymers; resins; metal ions; pharmaceuticals; biomaterials; living cells, etc. Applications for this embodiment may be used in applications such as 3D printing (potentially in combination with a XY or XYX moving stage of affixed to a robot arm); transport of reagents in bioprocessing platforms; organ/tissue printing; etc.

The principle of operation in the AQF ([8]) in the invention to droplet steering is focusing by alternating quadrupole electric field with use of variable focus position which is achieved by adjustment of both amplitudes and phases of voltages applied to the electrodes. This can be done by appropriate driving of the electrodes in the resistive plate apparatus or pillar electrodes. However, in the pillar electrode arrangement there is no electrode in the liquid nor is there a necessity to control the electrical potential on a target object onto which droplets are being deposited.

In other examples there may be vertically arranged “pillar” electrodes extending in the general direction of the droplet's trajectory, and arranged around the path of the droplets, and the velocity of droplets can be altered by altering the electric field between the pillar electrodes. One such arrangement is shown in FIG. 10, in which an apparatus 60 has four pillar electrodes 61, 62, 63, and 64, while a droplet is introduced into the region surrounded by the pillar electrodes

The main differences between the AQF approach and the FLS approach are: 1) use of alternating (AQF) or quasi-constant (FLS) electric fields; 2) AQF relies on air (gas) viscosity for settlement of the droplet, but FLS does not; 3) AQF is not sensitive to the sign of charge of the droplet so can process the simultaneously while FLS can only process droplets of one sign of charge at a time.

FIG. 11 is a plot of electrical potential arising from AQF driving and having a ‘saddle point’ which acts as a focusing point for the droplets, depicting an ideal target configuration of electrical potential or approximation of real potential in the vicinity of the saddle point. Such a configuration of electrical potential is preferably either modulated or rotated.

The practical benefit of the saddle-shaped field is that it defines a unique point in space (or unique point of any cross section of space) and the droplets of widely different parameters (e.g. charge, mass) are focused toward the saddle point which may be at any location within the space bounded by the electrodes. Such property enables deposition of droplets onto defined spot, free air levitated transport of droplets and selective merging of droplets in free air or other gas.

FIG. 12 is an example XY plot of electrical potential created by four cylindrical electrodes having a saddle point (marked) at X=7.0 mm, Y=3.7 mm, in which the amplitudes of the potential of the electrodes near the saddle point is the smallest. This applies particularly to the electrode configuration of FIG. 10.

FIG. 13 is a simulated example plot of XY plane droplet movement to a predefined target location, in a linear quadrupole electrostatic focusing device type structure, in which an excessive voltage amplitude causes overshoot of the motion toward the saddle point in which the droplet enters the trap at location (3.7, 1.6) and follows a path which brings it to a saddle point at location (0, 0), and the time taken for the droplet to reach the target location from the point of entry in this example is 85 ms;

FIG. 14 is a simulated example plot of slower XY droplet movement using a relatively low voltage, in which there is no significant overshoot of the movement, however the movement to the saddle point take a relatively long time, for example 2.6 s in the example shown.

FIG. 15 shows a simulation of steering a charged droplet using four electrodes, the plot showing droplet oscillatory micromotion which decreases in amplitude as the saddle point is approached. Also, FIG. 15 shows simulation of steering a charged droplet using four electrodes, in a linear quadrupole electrostatic focusing device type structure, the plot showing droplet oscillatory micromotion, which decreases in amplitude as the saddle point is approached.

FIG. 16 shows a simulation of a system having 16 electrodes, showing a circular pattern of droplet micromotion, such motion is characteristically exhibited by a charged droplet moving in the presence of a rotating saddle potential. Also, FIG. 16 shows simulation of a in a linear quadrupole electrostatic focusing device type system having 16 electrodes, showing a circular collapsing spiral type pattern of micromotion characteristic for the motion a droplet would exhibit in a rotating saddle potential.

FIG. 17 shows an example droplet generator and AQF steering apparatus 80 with a reservoir 81, a ring electrode 82 which defines a droplet path, four pilar electrodes 83, and a target plate 84 on which a droplet 85 is shown. Droplets are charged by the charging ring electrode 82, the droplets are simultaneously deflected and focused by the electrodes 83 toward a specific location 85 on the substrate 84. An electrode 86 provides control of the potential of the liquid in the reservoir 101. The target substrate 84 may also be located in the region enclosed by the pillar electrodes.

FIG. 18 shows an AQF quadrupole focusing/steering apparatus 90 with four pillar electrodes 91, high-voltage amplifiers 92 driven by a multichannel DDS (Direct Digital Synthesizer) 93 as the signal source. Control signals form a host computer 94 control the patterning sequence setting amplitude and phases of the DDS signals to the high voltage amplifiers 92.

In the AQF technique, the controlled precise deflection of the droplets is largely independent of their mass, charge/mass ratio, initial velocity, droplet liquid density, viscosity of the gas, such as air, through which the droplets are traveling while being guided. In the FLS variant of implementation, such independence might be achieved due to continuous simultaneous acceleration and deflection of the droplet by the electric field. This makes AQF distinctly different from the prior electrostatic deflection technology used in printers, in which acceleration of the droplets is implemented separately from deflection. Also, in some prior art the acceleration of the droplets is driven by mechanical pressure, not by electric field. In the AQF variant of implementation, the independence of droplet focusing position in respect to charge/mass ratio and other parameters is achieved by the known property of Quadrupole Focusing W. Adjustable focusing by variation of amplitude and phase of the electrode voltages is novel and particularly advantageous in the invention.

FIG. 19 illustrates one example of the voltages applied to four electrodes of either a FLS or a AQF structure. In the example shown, the amplitude of the voltage applied varies, while the phase between the voltages is zero. Such a configuration results in the steering/guiding of a droplet to a defined location, which is not co-axial with the axis of the FLS or a AQF structure.

FIG. 20 illustrates one example of the path travelled by droplets in an AQF type transport structure which has helical electrodes. In this example the linear path length travelled by the droplets being approximately 50 mm and taking approximately 0.3s. The droplets are initially introduced to the AQF type transport structure and take a short time to be captured by the electric field of the transport structure. Once the droplets are captured they travel in a helical pattern and experience a force coaxial to the electrode structure which propels them.

In summary, adjustable focusing in the invention involves: in the FLS variant simultaneous acceleration and deflection of the droplet by an electric field configuration created using a resistive plate; in the AQF variant—focusing of the droplets is achieved by specific configurations of a rotating electric field and the local axial symmetry in the region of the field's saddle point whereby the spatial location of saddle point (axis) can be defined by a set of applied voltage amplitudes and the relative phases of the applied voltages.

The guiding of droplets to a location of choice, using the AQF technique, is achieved by creating specific configuration of the electrical field enclosed in the space defined by the AQF electrodes. As described in detail below, the configuration of the electrical potential and field can be described analytically by rather simple equations while neglecting the edge effects on the sides of the guiding system.

It is known that while the potential inside a volume may be completely defined by the boundary conditions, no extremum of electric potential can be maintained at any location inside the volume. This prevents the use of static electric fields for creating potential minimas capable of focusing/steering droplets toward some predefined location. However, by providing the electric field configuration such that it maintains simultaneous acceleration/dragging and controlled deflection one can create the conditions when the droplets will be guided very accurately to the same spatial location despite a high degree of variation in their charge, mass, initial velocity or other parameters. The following formulas refer to FLS variant of implementation.

U(x,y,z)=Uz*z/h+Ux*x/L*z/h+Uy*y/L*z/h

Here
h—is height of the resistive plate over the target plane defined as z=0, having potential U(x,y,0)=0,
(x,y,z) are coordinates of the point inside the electrode system,
Uz is accelerating voltage.
Ux, Uy is x and y direction deflection voltages.

The potential at the resistive plate 6 defined as z=h is

U(x,y,h)=Uz+(Ux*x+Uy*y)/L

The resistive plate potential is defined by accelerating potential Uz and by superposition of two gradients.

The electric field can be obtained as negated derivative of the potential:

[Ex,Ey,Ez]=−[Ux*z/(L*h),Uy*z/(L*h],Uz/h+(Ux*x+Uy*y)/(L*h)]

The larger the cross-sectional area enclosed by the AQF electrodes the higher the voltage that is required for effective steering. Furthermore, a larger the cross-sectional area requires longer electrodes to avoid landing droplets at glancing angles which would compromise their placement precision. Generally, the recommended height of the resistive plate above the target substrate plane should be approximately double of the diameter of the print area. The recommended electric field strength is in order of 0.25 to 1 kV/mm for droplets of 10 μm to 100 μm diameter. That is assuming that the gas between the resistive plate and target substrate plate is standard atmospheric air at normal air pressure and hence the field strength is limited by the electric breakdown of air at high voltages.

Dense gases such as Sulphur Hexafluoride can be used to optimize performance for some particular applications, where increased damping of the droplet micromotion is advantageous. Printing droplets streamed at rates of up to 50 KHz over areas up to several cm in diameters using voltages up to tens of kV is achievable.

In some examples AQF embodiments the droplet flight time may be in the order of several milliseconds. For droplet charging potential of several hundred Volts the droplet-to-droplet interactions allow one to maintain dispense rate up to several kHz while maintaining accurate positioning of the droplets. The minimal required number of electrodes for two-dimensional steering is 4. Use of a higher number of electrodes is advantageous for: dispense over a larger area (locations closer to the electrodes can be utilized); or to achieve higher precision in droplet placement. In some embodiments, the number of electronic channels which power the electrodes may be substantially less than the number of electrodes (e.g. two times less). The electrodes may be connected to electronic channels in groups of repeating patterns. Alternatively, in other embodiments at least some of the electrodes can be electrically connected to other electrodes using resistive or capacitive voltage divider.

In the AQF technique, the required shape of electrical potential field which effectively guides a droplet to a predefined location is achieved by approximating, if not accurately creating, the needed shape of the electrical potential field by setting the boundary conditions i.e. electrode voltages. In the first approximation, numerical value of such boundary conditions can be obtained by extrapolating the above mentioned potential U(X, Y, t) to the coordinates of the electrodes. However, if the number of electrodes is small, e.g. 4, more sophisticated algorithm can be used to provide better approximation of the potential, particularly for dispersing to points having large off-centre position and close to the AQF electrodes.

Bothe the AQF and FLS methods can be further enhanced by means of feedback such as dynamic adjustment of the electrical potential field in response to variations either in the position, or properties (e.g. colour; contents; size, velocity), of the droplet by using optical or other droplet position sensors.

Furthermore, droplets that are detected to exhibit different properties (e.g. using the well-known techniques employed in optical cell sorting) may be directed to different locations while still in-flight. Either an AQF and FLS based system combined with a sensor capable of sensing a specific droplet property, (e.g. optical fluorescence), can provide selective deposition of different types of droplets such as required in biological cell sorting applications.

The system can be combined with droplet presence, or droplet size, sensors providing capabilities for precise estimation of the volume deposited. Such sensor can be based on the use of either discrete charge measurements associated with release or deposition of the droplet or average current measurements. Accordingly, it can use either liquid potential control electrode immersed in the liquid inside the reservoir or connected to the conductive target substrate plate or to the target object onto which the droplets are being deposited.

The system may alternatively use alternating positive and negative charging of the droplets resulting in average zero net electrical current induced in the liquid and thus avoiding the need to use a liquid potential control electrode immersed in the liquid inside the liquid reservoir and/or accumulation of charge on the target object surface.

In another AQF variant of the system the resistive plate can be used to setup oscillating or rotating quadrupole electric field thus providing dynamic focusing of the droplets. That allows the possibility to focus both negatively and positively charged droplets to the same location, assuming that they are falling under gravity. Furthermore, in another embodiment two streams of droplets can be forced to merge one-to-one above the surface in a controlled manner. The charged droplets while falling due to gravity pass through a multipole structure which acts as both deflection and focusing system. A key novelty and advantage of such a system is that the focusing and deflection of the droplets is largely independent of their charge polarity, quantity of charge or mass, charge/mass ratio, velocity, initial trajectory, droplet liquid density, and relatively independent of the viscosity of the gas such as air through which the droplets are traveling while being focused. Such set of features is a consequence of use of alternating electric field both for focusing and deflection. That places the current invention apart from widely used electrostatic deflection printers [11,12] or patent [2] where the use of superimposed constant electric field is proposed. It also different from [9] where quadrupole electrostatic field is only used for focusing and microprinting is based on mechanical scanning.

In AQF the guiding of the droplets to a location of choice is achieved by creating a specific configuration of an alternating electrical field potential through which the droplets are travelling. The configuration of the electrical potential though as being effectively two dimensional with little dependence on either the vertical coordinate of the droplet within the electrode structure or edge effects on the entrance/exit of the deflection/focusing system.

It is known from basic electrostatics that while the potential inside a volume may be completely defined by the boundary conditions, no extremum of electric potential can be maintained at any location inside the volume. This prevents the use of static electric fields for creating potential minima capable of focusing/steering droplets toward some predefined location. However, by manipulating the voltages applied to 4 or more electrodes one can create a saddle point in a range of locations between the electrodes. The following formulas refer to the AQF variant of implementation. The electric potential saddle point can be approximated as:

U(x,y)=Uo*(x*x−y*y)/(2*R*R),
where R—is radius of electrode placement from the centre of the electrode system, (x,y) are coordinates of a given point inside space bounded by the electrodes, Uo is voltage amplitude applied.

The potential having some saddle point (x0, y0) can be approximated as:

U(x,y)=Uo*((x−x0)*(x−x0)−(x−x0)*(x−x0))/(2*R*R)

Such pattern can be either modulated in time or rotated around the saddle point. The corresponding time dependent potential can be described as follows:

For the case of modulation:

Ut(x,y,t)=U(x,y)*sin(w*t)

For the case of rotation:

Ut(x,y,t)=U(x′,y′) where

x′=x*cos(w*t)−y*sin(w*t)

y′=y*cos(w*t)+x*sin(w*t)
where t is time and w is phase frequency of the modulation or rotation.

The wider the area the higher voltage is required for effective steering/guiding of droplets, however the efficiency of steering can be improved if using a rotating saddle pattern as compared to the oscillating pattern. The disadvantage of the rotating pattern is that it requires phase shifted signals for at least some electrodes which moderately complicates the implementation of the electronics needed to drive the system.

While non-sinusoidal voltage modulation may be used to drive the system electrodes, in order to alter the velocity of droplet in free space, generally it does not provide any advantages as it is more complex to implement.

The required potentials can range from tens of Volts to tens of Kilovolts, the frequency typically being in range from several Hz to several KHz. The implementations of such signal amplifiers together with multichannel DDS [Direct Digital Synthesizer] is within the scope of available electronic solutions. A range of solutions can be used such as high voltage thermionic valves, Silicon Carbide based High Voltage transistors, or loaded High Voltage rectifiers. The electrodes may be fed via AC [Alternating Current] coupling stage to force the average potential to a constant defined value.

The minimal required number of electrodes for AQF is 4. Use of a higher number of electrodes allows to disperse over wider area (locations closer to the electrodes can be utilized) and achieve higher precision. In some variants, the number of electronic channels can be substantially less than the number of electrodes (e.g. two times less). The electrodes can be connected to electronic channels in groups of repeating patterns. Alternatively, at least some of the electrodes can be connected to others using resistive or capacitive voltage divider.

In all implementations of the AQF technique, the required shape of the electrical potential having a saddle point in a predefined location is achieved by approximating the needed shape of the potential by setting the boundary conditions (electrode voltages). In the first approximation, the numerical value of such boundary conditions can be obtained by extrapolating the above mentioned potential U(x,y,t) to the coordinated of the electrodes. However, if the number of electrodes is small, e.g. 4, more sophisticated algorithm can be used to provide better approximation of the saddle potential, particularly for dispersing to locations having large off-centre position i.e. farther from the central axis of the AQF electrodes.

In the case of AQF, while travelling to the saddle point the droplet experience either oscillatory or rotational micromotion (accordingly to the potential used). In both cases the micromotion settles to zero once the saddle point is reached unless there are disturbing force present. If there is a disturbing force (e.g. constant electric field or significant air motion) some amplitude of micromotion will persist thus cancelling such disturbance by averaged electric field forces. Mathematical analysis of object movement in rotating or oscillating saddle potential can be found in [10].

While approaching the target substrate the droplet may experience some disturbances associated with the electric filed deviating near the substrate. Such deviations can be minimized by a combination of appropriate adjustment of the driving electrode potentials and matched control of the potential of the substrate.

In other implementations, to optimize parameters like precision of the droplet placement or the usable area where droplets can be accurately guided, the cross-section bounded by the electrodes can be increased or/and the number of electrodes increased. In addition, the potentials applied to the AQF electrodes, in particular their modulation frequency or/and amplitudes or/and phase can be tuned or varied through the flight time of a single droplet in order to improve positioning accuracy.

In applications such as 3D printing one may use an AQF type structure for the transport of charged droplets in a droplet guide with either straight or helical electrodes as is appropriate for the given application. For example, one example of such a AQF based droplet guides can be provided using helically twisted electrodes excited by high voltage waveforms. The exciting high voltage waveforms would, as in the case of a normal AQF implementation create a quadrupole rotating field, however furthermore be modulated with eccentricity which is also slowly rotating about the central axis of the droplet guide. This eccentricity displaces the saddle point from the central axis of the droplet guide and slowly rotates the saddle point at a distance from the central axis of the droplet guide (several times slower than period of quadrupole rotating field). Such a configuration effectively creates gradual propulsion of the droplet along the tube while keeping it actively levitated inside the tube. See FIG. 9. The electrical forces experienced by the droplet are many times greater than gravity. For example, focused ultrasonic droplet ejection or inkjet droplet ejection can be used to generate a droplet to be transported. An example waveform of such a type can be described as following, here W is eccentricity rotation frequency:

Ut(x,y,t)=U(x−d*sin(W*t),y−d*cos(W*t))*sin(w*t),

where U(x,y)=Uo*(x*x−y*y)/(2*R*R)

Use of alternative (AC) electric filed based droplet propulsion bring advantage over known constant field-based droplet guides. It allows the use of much lower voltages and does not limit the length of the droplet guide. Note that the use of a superimposed rotating eccentricity make it distinct from known helical (twisted) guides of charged particles or droplets such as the one described in [7] or [16].

The special AQF embodiment for droplet transport is robust to variations in the droplet parameters such as initial velocity and trajectory, mass or charge to mass ratio. In addition, reliable detection of dispensing of such droplets using the aforementioned charge amplifier approach is very beneficial, as it allows for the determination of when a droplet exits the droplet guide or is deposited on the target object. While optical detection approaches exist, they are problematic in many situations where the distance between the nozzle where the droplet is ejected from and the surface where the droplet is deposited is small.

The droplets are accelerated by axial component of alternating electric field arising in structure which preferably has electrodes of mutually twisted helical shape and/or which are flexible, thus proving guiding and acceleration of the droplets.

Great advantages of such levitated droplet transport e.g. compared to microfluids include:
1. Avoidance of cross contamination of the liquids used
2. Fast switching between several liquids, fast delivery of liquids
3. Very small minimal volume of the liquid is required for operation
4. Can be easily combined the droplet sorting mechanisms

A practical example of such implementation is as follows:

Operational Parameters:
Droplet diameter (water droplet used)=35 um
Droplet charging potential=400V
Tube diameter=10 mm
Number of electrodes=8, electrode diameter=1 mm
Helical twist period of the electrode twist pattern along the tube=40 mm
Amplitude of the sinusoidal voltage applied=5 kV
Electrical frequency: Pattern rotation w=400 Hz, Eccentricity rotation frequency W=10 Hz
Eccentricity parameter (ratio of saddle position rotation diameter to the tube diameter)=0.5
Calculated parameters (from numerical simulation):
Average sustained droplet propulsion speed along the tube 40 mm*10 Hz=400 mm/sec
Mircromotion radius (max deviation from focused trajectory) caused by gravity acting in any direction dr=0.18 mm

### Alternative Example Embodiments

Reference is made to FIGS. 21, 22, and 23. As shown in FIG. 21 a cube-shaped structure 200 has six mutually insulated sides. Each side is conductive and forms a single electrode. Two opposed sides have apertures 205 and 206, and dispensers 201 and 202 are mounted to be aligned with these apertures respectively. There is also an exit aperture 207 in a lower side, at right angles to the sides with the apertures 205 and 206. The structure 200 has opposed electrodes 210 and 211 facing in the longitudinal direction (X axis) of the dispensers 201 and 202. There are also two pairs of orthogonal Y and Z axis pairs of electrodes 212/213, and 214/215. The electrode 215 has the exit aperture 207. In this example, each pair of electrodes is linked with the same Voltage source as illustrated, but the three pairs of opposed electrodes are driven out of phase by 120°, as illustrated.

The structure 200 may be regarded as a droplet manipulation enclosure, into which droplets are delivered from the dispensers 201 and 202 and, droplets of different liquids can be injected by the dispensers 201 and 202 and merged in the chamber, the mixed droplet can exit the enclosure via the exit aperture 207. In other applications a droplet of a single fluid or a mixture of fluids can be suspended in free space in the cube structure. The suspended droplet may then be interrogated by for example a laser or x-ray source.

By way of example, droplets M1 and M2 are ejected from the dispensers 201 and 202 via the orifices 205 and 206 respectively. M1 and M2 are droplets which have been electrically charged, one with a positive potential and the other with a negative potential. The charging of the two droplets is asymmetric, such that one of them is more charged than the other, such that when they merge the resultant merged droplet still retains an electrical potential. M1 and M2 are merged to form one droplet M3, by virtue of the electrical potentials applied to the electrodes which are the walls of the structure 200.

M3 may be levitated within the enclosure 200. Then, by using controlled amplitude and phase the merged droplet M3 might be deposited to a selected location M4. Alternatively, the droplet M3 may be ejected via the orifice 207 as an external droplet M5 where it can be deposited or further manipulated. As shown in FIG. 22 the enclosure 200 may be mounted so that the exit aperture 207 is aligned with the aperture 10 of the resistive plate of the apparatus 1. For clarity, the representative illustrations of FIG. 21 are omitted from FIG. 22.

As shown in FIG. 23 a number of the enclosures may be mounted juxtaposed with interconnecting apertures. In this illustrated example an apparatus 300 has aligned cuboid enclosures 301, 302, and 303 with pairs of apertures 326 and 327 connecting their volumes. In this case each enclosure 301, 302, and 303 has an inlet aperture 320, 322, and 324 respectively. This arrangement allows very versatile delivery of droplets into a selected combination of the enclosures and driving of any desired combination of the twelve enclosure sides to achieve the desired droplet manipulation. In this case there is one exit aperture per enclosure, the enclosures 301, 302, and 303 having exit apertures 321, 323, and 325 respectively, each of which is aligned with its respective inlet aperture and dispenser. It is envisaged however that not all of the enclosures have an inlet and/or an outlet aperture. For example, there may be one or two inlet apertures in total and one or two outlet apertures in total, allowed by the fact that the manipulation can guide the droplets towards the selected enclosure with a desired outlet aperture.

The apparatus of FIG. 23 is an example of a three-dimensional structure of concatenated enclosures or “chambers” where droplets can be merged, levitated, exchanged, stored or ejected from.

### EXAMPLE

In one example the arrangement of FIG. 21 was used, with electrodes on all six sides, each side being a single electrode of size 25 mm×25 mm, of TiO2 conductive glass material, and an AC voltage is applied with a peak value of 3.5 kV to each opposed pair of the six sides. The dispensers 201 and 202 are acoustic dispenser (PolyPico Technologies Ltd.) with a 70 μm dispensing cartridge and a 50 um dispensing cartridge respectively.

Droplets were dispensed with an average size of 40 μm diameter on one side and 70 μm from the opposed dispenser. The droplets were injected by the acoustic dispenser with an inertia and there is additional force applied by the nearest cube side applying an electrostatic force to draw the droplets through the relevant aperture. Hence, the droplet dispensing is in synchronism with the charging of the plate with the aperture. For example, where the droplets have a negative charge, the dispensing is done while the plate with the aperture has a positive charge, for example this point in time may correspond to the crest of an AC voltage cycle which is applied to the electrode.

For example, if the apparatus is configured to merge droplets, the same AC voltage is applied to both opposed sides, and in phase, thereby causing the droplets to converge in the centre along the axis through the opposed sides. Three similar AC voltage waveforms are applied to the opposite faces of the cube, this causes merging of the droplets after their travel time of about 10 ms from the dispenser to the centre.

Once droplets have converged and merged in the centre, the voltages are changed so that the plate with the outlet aperture is charged the opposite to the net charge of the merged droplet. For example, droplets of 40 μm and 70 μm are merged, the small one being negative and the large one being positive, thereby producing a net positive merged droplet. In order to eject the microdrop from the chamber the plate with the outlet aperture is made to be negatively charged.

In the above examples there are three pairs of opposed plates, however it is envisaged that the invention may encompass only two pairs of opposed plates, and so the “chamber” is open on two sides, with only four electrodes. Also, the electrode plates need not necessarily be joined at their edges, and the gap between the plates may have insulation in order to provide electrical isolation between the individual electrodes.

A feedback mechanism may be used to control the electrical potential of the AQF pillar electrodes in order to control the trajectory of the droplet while inside the space bounded by the AQF electrodes.

In other embodiments a potential may be applied to a plate which is under the target object onto which droplets are being dispensed, and this plate may be patterned such that the electrical potential is concentrated at certain locations which may attract or repel droplets, see FIG. 5.

The apparatus may include a sensor other than a charge amplifier such as the 142A series of preamplifiers by Ortec Inc. for the detection of droplet presence or size, and a processor may process the sensor signal in order to estimate the volume of fluid dispensed.

In certain embodiments of the AQF technique, the droplets may be sorted and dynamically deposited to different locations based on their estimated properties.

In some examples, the electrodes are driven so that the droplets are intentionally merged in free space by being focused to the same location.

In certain embodiments of the AQF technique, the droplets may be stored, in free space within the bounds of the AFQ structure.

In certain embodiments of the AQF technique, a combination of coaxial and spiral electrodes may be used for the transport of droplets.

The invention is not limited to the embodiments described but may be varied in construction and detail. Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features. It is envisaged that an apparatus may include electrodes both on a resistive plate and also in a three-dimensional pillar or spiral arrangement. Also, it is envisaged that the apparatus may be used for guiding a filament for an application such as electrospinning. Hence, the word “droplet” isn't limited to drops, but to filaments also. The apparatus of the invention may be used with droplets or particles in the size ranges described, and it is intended that the word “droplet” includes particles unless it is specified that they are of liquid.

1-58. (canceled)

59. A droplet or particle steering apparatus comprising:
a liquid reservoir,
a steering guide comprising a plurality of electrodes which create an electric field through which a droplet travels while being controlled in two or three spatial dimensions, wherein the electrodes are part of a resistive plate which extends around a droplet path towards a target, and
a voltage driver for applying potentials to the electrodes according to control signals from a controller to steer a path of the droplets.

60. The apparatus as claimed in claim 59, wherein there are at least three electrodes on the plate, and the resistive plate has a hole through which the droplet path extends substantially perpendicularly to the plate.

61. The apparatus as claimed in claim 59, wherein the apparatus comprises an electrode in the reservoir, and the voltage driver is configured to control potential across said reservoir electrode and the electrodes of the resistive plate.

62. The apparatus as claimed in claim 59, wherein the apparatus comprises an electrode through which the drops travel, to charge the droplets and the controller is configured to control potential across said electrode and the electrodes of the resistive plate.

63. The apparatus as claimed in claim 59, further comprising a target substrate, wherein the apparatus comprises a reservoir electrode in the reservoir arranged to contact liquid in the reservoir, and the voltage driver is configured to control potential across said reservoir electrode and the electrodes of the resistive plate, and wherein the controller is adapted to apply a greater potential to the reservoir electrode than that of a target substrate.

64. The apparatus as claimed in claim 59, further comprising a target substrate, wherein the apparatus comprises an electrode in the reservoir arranged to contact liquid in the reservoir, and the voltage driver is configured to control potential across said reservoir electrode and the electrodes of the resistive plate, and wherein the controller is adapted to apply a greater potential to the reservoir electrode than that of a target substrate, and wherein the potential difference between the reservoir electrode and the target substrate is greater than 4000V.

65. The apparatus as claimed in claim 59, further comprising a target substrate, wherein the controller is configured to cause simultaneous electrostatic acceleration and two-dimensional electrostatic deflection due to potential gradient across a gap between the resistive plate and the target substrate and across the resistive plate.

66. The apparatus as claimed in claim 59, further comprising a target substrate, wherein the controller is configured to cause simultaneous electrostatic acceleration and two-dimensional electrostatic deflection due to a potential gradient across a gap between the resistive plate and the target substrate and a potential gradient across the resistive plate; and wherein the controller is configured to vary potential between the resistive plate and the target substrate to alter acceleration of the droplets, whereby deflection and acceleration of droplets is performed simultaneously to increase precision of the droplet positioning on the target substrate.

67. The apparatus as claimed in claim 59, wherein:
the apparatus comprises a target substrate,
the apparatus comprises a reservoir electrode in the reservoir, and the voltage driver is configured to control potential across said reservoir electrode and the electrodes of the resistive plate;
the controller is configured to cause simultaneous electrostatic acceleration and two-dimensional electrostatic deflection due to a potential gradient across a gap between the resistive plate and the target substrate and a potential gradient across the resistive plate; the controller is configured to vary potential between the resistive plate and the target substrate to alter acceleration of the droplets and cause simultaneous deflection and acceleration of droplets to increase precision of the droplet positioning on the target substrate;
the controller is configured to vary potential difference between the liquid reservoir and the centre of the resistive plate to control level of inductive charging of droplets, in which the potential of the centre of the resistive plate being equal to an averaged potential of the resistive plate electrodes.

68. The apparatus as claimed in claim 59, wherein the controller is configured to control the electrodes to provide a dispense pattern in which dispensing starts in a central location, so minimising placement deviation due to unsettled parameters of the first droplets dispensed.

69. The apparatus as claimed in claim 59, further comprising a target substrate, and wherein:
the controller is configured to control the electrodes to provide a dispense pattern in which dispensing starts in a central location, so minimising placement deviation due to unsettled parameters of the first droplets dispensed; and
the controller is configured to cause dispensing of droplets on the target substrate in a hexagonal grid pattern in which distance to all neighbour droplet spots are equal.

70. The apparatus as claimed in claim 59, wherein the potential difference across at least two electrodes is in the range of 100 V to 300 kV.

71. The apparatus as claimed in claim 59, further comprising a target substrate and patterned electrodes in a plate underneath the target substrate, wherein the plate is patterned such that the electrical potential of the electrodes of the plate is concentrated at locations which may attract or repel droplets.

72. The apparatus as claimed in claim 59, wherein the controller is configured to apply drive signals so that droplets are merged in free space by being focused to the same location.

73. The apparatus as claimed in claim 59, wherein the controller is configured to apply an alternating quadrupole electric field with use of variable focus position which is achieved by adjustment of both amplitudes and phases of voltages applied to the electrodes.

74. The droplet or particle steering apparatus as claimed in claim 59, comprising three-dimensional electrodes having a dimension substantially parallel to a droplet path.

75. The apparatus as claimed in claim 74, wherein the controller is configured to drive the three-dimensional electrodes with application of a saddle-shaped field that defines a saddle point in space whereby droplets of different parameters are focused towards the saddle point.

76. The apparatus as claimed in claim 74, wherein the controller is configured to drive the three-dimensional electrodes with application of a saddle-shaped field that defines a saddle point in space whereby droplets of different parameters are focused towards the saddle point; and wherein said parameters include at least one selected from charge and mass

77. The apparatus as claimed in claim 74, wherein the controller is configured to drive the three-dimensional electrodes with application of a saddle-shaped field that defines a saddle point in space whereby droplets of different parameters are focused towards the saddle point; and wherein the controller is configured to drive the electrodes such that the location of the saddle point within the space bounded by the electrodes is controlled.

78. The apparatus as claimed in claim 74, wherein the controller is configured to drive the electrodes for:
deposition of droplets onto a defined location, and/or
free air levitated transport of droplets, and/or
elective merging of droplets in free air or other gas.
